(19) United States
(12) Patent Application Publication
(10) Pub. No.: US 2012/0280667 A1
(43) Pub. Date: Nov. 8, 2012

(54) Flexible load current dependent feedback compensation for linear regulators utilizing ultra-low bypass capacitances

(75) Inventors: Stephan Drebinger, Munich (DE); Marcus Weis, Munich (DE); Liu Liu, Germering (DE)

(73) Assignee: Dialog Semiconductor GmbH

(21) Appl. No.: 13/136,257

(22) Filed: Jul. 27, 2011

(30) Foreign Application Priority Data
May 3, 2011 (EP) EP11164560.2

(51) Int. Cl. G05F 1/10

(52) U.S. Cl. 323/273

(57) ABSTRACT

The present document relates to low-dropout (LDO) regulators having low output capacitance. The regulator comprises a differential amplification stage configured to amplify a differential voltage between a reference voltage and a measure of the output voltage, thereby yielding a drive current at an output of the amplification stage; a subsequent output amplification stage configured to provide the regulated output voltage and a output current at an output of the output amplification stage, based on a drive voltage at an input of the output amplification stage; and a first output current feedback loop configured to sense the output current; and feed back a first coupling current derived from the sensed output current to a first intermediate point between the output of the differential amplification stage and the input of the output amplification stage; wherein the drive voltage is dependent on the drive current and the first coupling current.

The present document relates to linear regulators or linear voltage regulators configured to provide a constant output voltage. In particular, the present document relates to low-dropout (LDO) regulators having ultra-low output capacitance.

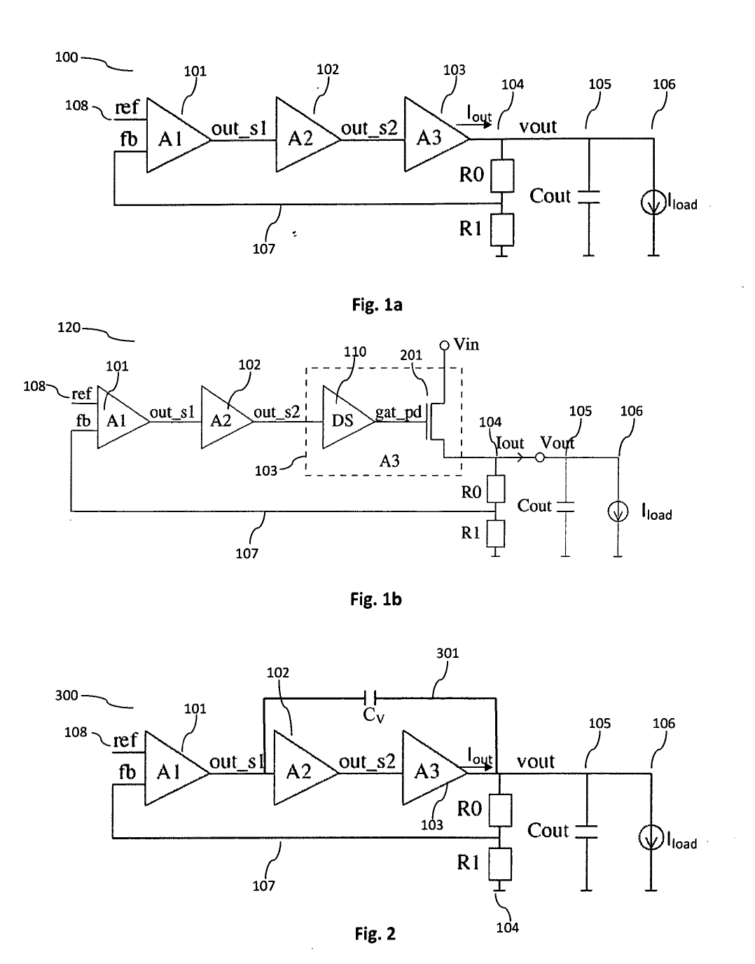

Low-dropout (LDO) regulators are linear voltage regulators which can operate with small input—output differential voltages. A typical LDO regulator 100 is illustrated in FIG. 1a. The LDO regulator 100 comprises an output amplification stage 103, e.g. a field-effect transistor (FET), at the output and a differential amplification stage or differential amplifier 101 (also referred to as error amplifier) at the input. A first input (fb) 107 of the differential amplifier 101 receives a fraction of the output voltage Vₒᵤₜ determined by the voltage divider 104 comprising resistors R0 and R1. The second input (ref) to the differential amplifier 101 is a stable voltage reference V_{ref} 108 (also referred to as the bandgap reference). If the output voltage Vₒᵤₜ changes relative to the reference voltage V_{ref}, the drive voltage to the output amplification stage, e.g. the power FET, changes by a feedback mechanism called main feedback loop to maintain a constant output voltage Vₒᵤₜ.

The LDO regulator 100 of FIG. 1a further comprises an addition intermediate amplification stage 102 configured to amplify the output voltage of the differential amplification stage 101. As such, an intermediate amplification stage 102 may be used to provide an additional gain within the amplification path. Furthermore, the intermediate amplification stage 102 may provide a phase inversion.

In addition, the LDO regulator 100 comprises an output capacitance Cₒᵤₜ (also referred to as output capacitor or stabilization capacitor or bypass capacitor) 105 parallel to the load 106. The output capacitor 105 is used to stabilize the output voltage Vₒᵤₜ subject to a change of the load 106, in particular subject to a change of the load current I_{load}. It should be noted that typically the output current Iₒᵤₜ at the output of the output amplification stage 103 corresponds to the load current I_{load} through the load 106 of the regulator 100 (apart from typically minor currents through the voltage divider 104 and the output capacitance 105). Consequently, the terms output current Iₒᵤₜ and load current I_{load} are used synonymously, if not specified otherwise.

Typical values or sizes of the output capacitor 105 which are necessary to obtain a reasonable stable output voltage Vₒᵤₜ are in the range of 1 μF. Capacitors of this size have the disadvantage that they cannot be integrated onto the same chip or package as the LDO regulator, thereby yielding increased manufacturing costs and a lower degree of integration. As such, the size of the capacitors may significantly impact the footprint of a chip or package, thereby increasing the cost of the chip or of the entire application. Typically, these bypass capacitors 105 are placed externally at an output of the LDO regulator circuit.

In view of the above, the present document is directed at a Low-Drop-Out regulator for small output capacitances. It is an objective to reduce the size or capacitance of a bypass capacitor. It is a further objective to avoid any external bypass capacitor. The LDO regulator should be stable with ultra-low bypass capacitors in order to support e.g. the use of capacitors of the 201 series. In particular, it is an object to provide an LDO regulator with stable operation for ultra-low load capacitors (e.g. in the range of 20 nF-200 nF). Stability of the output voltage Vₒᵤₜ should be achieved without relying on the equivalent serial resistance (ESR) of the bypass capacitor or on the bondwire resistance (chip-scale-package), i.e. regardless the type of bypass capacitor which is used. In an embodiment, the LDO regulator should support a scalable output current of up to 400 mA. Furthermore, the LDO regulator should provide a fast transient response, subject to load changes (e.g. from 0 mA to 200 mA and/or from 1 mA to 200 mA). In addition, it is desirable to provide a LDO regulator at ultra low power consumption.

According to an aspect, a circuit arrangement, e.g. a linear regulator, is described. In particular, the circuit arrangement may be a low drop-out voltage regulator. The circuit arrangement or linear regulator may be configured to regulate an output voltage of the regulator subject to a reference voltage at the input of the regulator.

The regulator may comprise a differential amplification stage configured to amplify a difference signal. The difference signal may be determined at an input of the differential amplification stage. In particular, the difference signal may be determined from the reference voltage and a measure of the regulator output voltage. By way of example, the difference signal may be the difference between the reference voltage and the measure of the regulator output voltage. The measure of the regulator output voltage may be a fraction of the output voltage, e.g. derived using a voltage divider. The voltage divider may be positioned at the output of the regulator, e.g. parallel to a load connected to the regulator. As a result of the differential amplification, an output voltage and an output current may be obtained at an output of the differential amplification stage.

The circuit arrangement or regulator may comprise an output amplification stage. Typically, the output amplification stage is positioned subsequent or downstream from the differential amplification stage. In particular, the output amplification stage may be positioned at the output of the regulator, and the differential amplification stage may be positioned at the input of the regulator. The output amplification stage may be configured to provide the regulated output voltage and a output current at the output of the output amplification stage. The regulated output voltage and the output current may be provided as a function of a drive voltage at an input of the output amplification stage.

In an embodiment, the output amplification stage comprises a pass transistor, e.g. a field effect transistor such as a PMOS or NMOS transistor, having a gate, a source and a drain. The regulated output voltage may be the voltage at the drain of the pass transistor, and the output current may be the source to drain current of the pass transistor. Typically, the pass device is controlled by the gaze voltage which may be coupled to the drive voltage.

The circuit arrangement or the regulator may comprise a first output current feedback loop configured to sense the output current. In other words, the first output current feedback loop may comprise output current sensing means configured to sense or to measure or to gauge the output current at the output of the output amplification stage. By way of example, the output current may be sensed or gauged by a current mirror, with the pass transistor of the output amplification means being an element of the current mirror, e.g. the first transistor of the current mirror.

The first output current feedback loop may be further configured to feed back a first coupling current derived from or determined from the sensed or gauged output current. The sensed or gauged output current may be fed back to a first intermediate point or node between the output of the differential amplification stage and the input of the output amplification stage. In particular, the first output current feedback loop may comprise output current amplification means configured to amplify or attenuate the sensed output current, thereby yielding a scaled output current. As such, the first coupling current may be derived from or determined from the scaled (i.e. amplified or attenuated) sensed output current.

In an embodiment, the regulator, and in particular the first output current feedback loop, comprises a feedback transistor. The feedback transistor may form a current mirror in conjunction with a pass transistor comprised within the output amplification means. Such a current mirror may provide the output current sensing means and the output current amplification means.

As a result of feeding back the first coupling current, the drive voltage, i.e. the voltage which may be used to control the regulated output voltage and/or the output current provided by the output amplification stage, may depend on the output current of the differential amplification stage and the first coupling current.

In particular, the drive voltage may be determined by the differential amplifier output current, the first coupling current and the output impedance of the differential amplifier. As will be outlined in further detail in the present document, as a result of the combination of the control of the regulated output voltage via the differential amplification output current (which depends on a difference signal between the reference voltage and a measure of the regulator output voltage) and via a fed back first coupling current (which is derived from the sensed or gauged output current), a linear regulator may be provided which is stable to transient output currents.

The first output current feedback loop may comprise a current coupling unit configured to determine the first coupling current from the scaled output current. For this purpose, the current coupling unit may comprise a coupling characteristics circuit configured to convert the scaled output current into a coupling voltage. Such a coupling characteristics circuit may comprise any combination of one or more resistors, one or more transistors, one or more diodes, one or more capacitances, and one or more inductances. By way of example, the coupling characteristics circuit may be a resistor, thereby providing a coupling voltage which is proportional to the scaled output current. In general terms, the coupling characteristics circuit may be used to obtain a desired linear or non-linear relationship between the scaled output current and the coupling voltage.

The current coupling unit may further comprise a coupling capacitance configured to convert a change of the coupling voltage into the first coupling current. The coupling capacitance may be positioned in parallel to the coupling characteristics circuit, thereby ensuring that the coupling voltage provided by the current circuit corresponds to the voltage at the coupling capacitance. As such, the coupling capacitance may be configured to determine the first coupling current as a derivative (with respect to time) of the coupling voltage.

Overall, it may be stated that the first current feedback loop may be configured to determine a first coupling current as a derivative (with respect to time) of a desired function of the sensed or gauged output current. The desired function of the sensed or gauged output current may be designed using the coupling characteristics circuit so as to provide a particular feedback characteristic. As such, the function may be a linear function (e.g. when using a resistor) or a non-linear function (comprising e.g. a diode, transistor, inductance, etc.) of the sensed or gauged output current. In an embodiment, the first coupling current is proportional to a derivative (with respect to time) of the scaled (sensed or gauged) output current. Overall, it may be stated that using the coupling characteristics circuit, an operating point and the characteristics (e.g. the slope) of the output current feedback loop may be defined. The operating point and the characteristics of the output current feedback loop typically depend on the sensed output current, i.e. on the range of the sensed output current.

The feedback of the coupling current may be implemented by coupling or linking or connecting the output of the first output current feedback loop with the output of the differential amplification stage at the first intermediate point. The first intermediate point may be positioned on the amplification path between the output of the differential amplification stage and the input of the output amplification stage. In particular, one end of the coupling capacitance may be linked or connected to the output of the differential amplification stage, thereby linking the differential amplifier output current and the first coupling current. The other end of the coupling capacitance may be linked or connected to the output of the load current amplification means. In particular, the other end of the coupling capacitance may be linked or connected to the output of the current mirror implementing the load current amplification means.

The regulator may comprise one or more intermediate amplification stages coupled between the output of the differential amplification stage and the input of the output amplification stage. In this case, the first intermediate point may be positioned at various places on the amplification path of the regulator. The selection of the first intermediate point, i.e. of the point of feedback of the first coupling current, may be used to optimize the stability and the convergence of the regulated output voltage in dependence on the range of the regulator output current. By way of example, the first intermediate point may be positioned between the output of the differential amplification stage and an input of the one or more intermediate amplification stages, or the first intermediate point may be positioned between an output of the one or more intermediate amplification stages and the input of the output amplification stage. If the regulator comprises more than one intermediate amplification stage, the first intermediate point may be positioned between an output of a first intermediate amplification stage and an input of a second, subsequent, intermediate amplification stage.

The regulator may further comprise a second output current feedback loop configured to feed back a second coupling current derived from the sensed output current to the first intermediate point, or a different second intermediate point between the output of the differential amplification stage and the input of the output amplification stage. As such, the drive voltage may be further dependent on the second coupling current. In a similar manner to the first output current feedback loop, the second output current feedback loop may comprise output current sensing means (e.g. shared with the first output current feedback loop), output current amplification means (e.g. a second feedback transistor forming a second current mirror together with the pass transistor), and a current coupling unit comprising a coupling characteristics circuit and a coupling capacitance.

Typically, the design parameters of the components of the second output current feedback loop are different from those of the first output current feedback loop. Such design parameters may be a scaling factor of the sensed output current, the value of the coupling capacitance and/or the feedback function provided by the coupling characteristics circuit. In particular, the first and second output current feedback loops may be configured such that the first and second coupling currents exceed a threshold current for different ranges of the sensed output current. Alternatively or in addition, the first and second output current feedback loops may be configured such that the first and second coupling voltages exceed a threshold voltage for different ranges of the sensed output current. In a similar manner to the first coupling voltage, the second coupling voltage may be derived from the sensed or gauged output current using a coupling characteristics circuit within the second output current feedback loop.

Overall, it should be noted that the regulator may comprise a plurality of output current feedback loops. The different output current feedback loops may be configured to ensure a stable and fast operation of the regulator subject to transient output currents within different (possibly overlapping) current ranges.

The regulator may comprise an output capacitance parallel to the load. Alternatively, the regulator may provide an output voltage at a load with a parallel output capacitance. For regulators having an output voltage in the range of 1V to 5.5V, and an output current in the range of 1 mA to 400 mA, the output capacitance may be smaller or equal to 200 nF, 150 nF, 100 nF, 80 nF, 70 nF, 60 nF, 50 nF or 40 nF. It should be noted that these numbers are only examples for possible embodiments and the inventive concept may be applied to regulators with different dimensions.

The regulator may comprise a Miller compensation loop configured to feed back the output voltage to a third, possibly different, intermediate point between the output of the differential amplification stage and the input of the output amplification stage. The Miller compensation loop may comprise a Miller capacitance.

According to a further aspect, a method for regulating an output voltage subject to a reference voltage is described. The method may comprise the step of amplifying a difference between the reference voltage and a measure of the output voltage, thereby yielding an output current at an output of a differential amplification stage. The method may proceed in providing the regulated output voltage and an output current at an output of an output amplification stage, based on a drive voltage at an input of the output amplification stage. Furthermore, the method may comprise the steps of sensing the output current, and of feeding back a first coupling current derived from the sensed output current to a first intermediate point between the output of the differential amplification stage and the input of the output amplification stage. The drive voltage may be dependent on the differential amplifier output current and/or the first coupling current and/or an output impedance of the differential amplification stage.

It should be noted that the methods and systems including its preferred embodiments as outlined in the present patent application may be used stand-alone or in combination with the other methods and systems disclosed in this document. Furthermore, all aspects of the methods and systems outlined in the present patent application may be arbitrarily combined. In particular, the features of the claims may be combined with one another in an arbitrary manner.

The invention is explained below in an exemplary manner with reference to the accompanying drawings, wherein

FIG. 1a illustrates an example block diagram of an LDO regulator;

FIG. 1b illustrates the example block diagram of an LDO regulator in more detail;

FIG. 2 illustrates an example block diagram of an LDO regulator with Miller compensation;

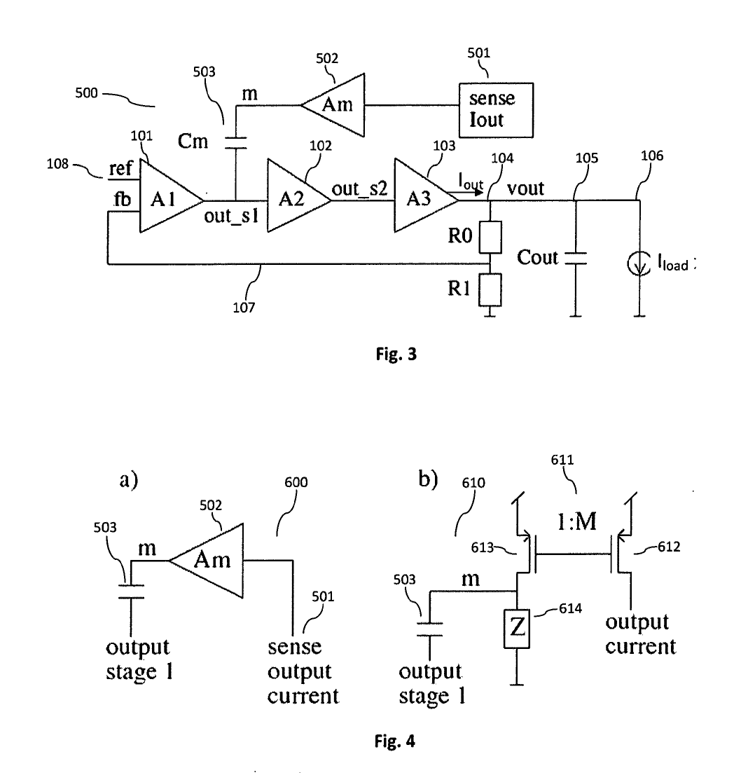

FIG. 3 illustrates an example block diagram of an LDO regulator with load current dependent feedback;

FIG. 4 illustrates example implementations of the load current feedback loop of FIG. 3;

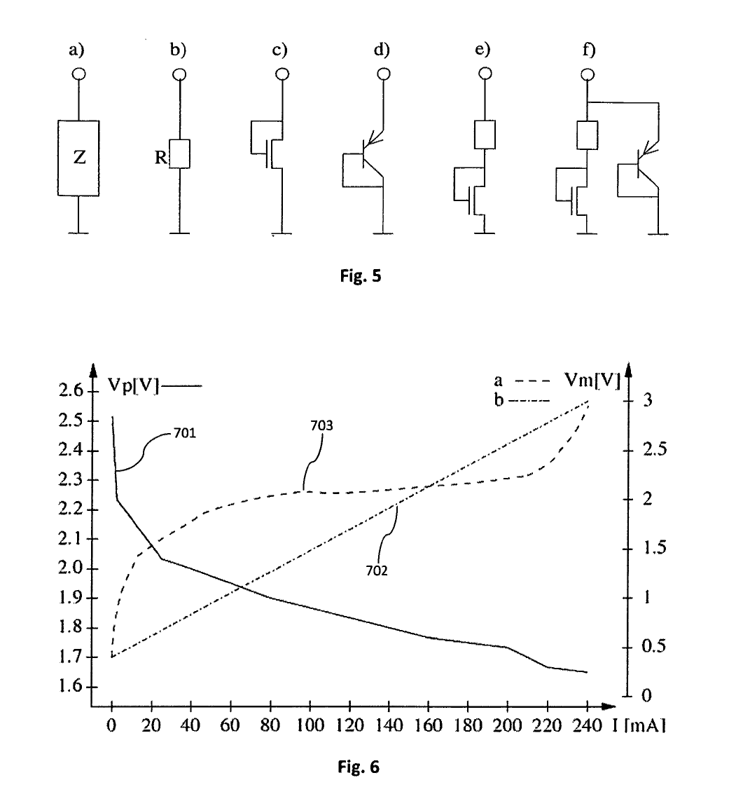

FIG. 5 illustrates examples for feedback characteristics units;

FIG. 6 illustrates example feedback characteristics of the load current dependent feedback loop;

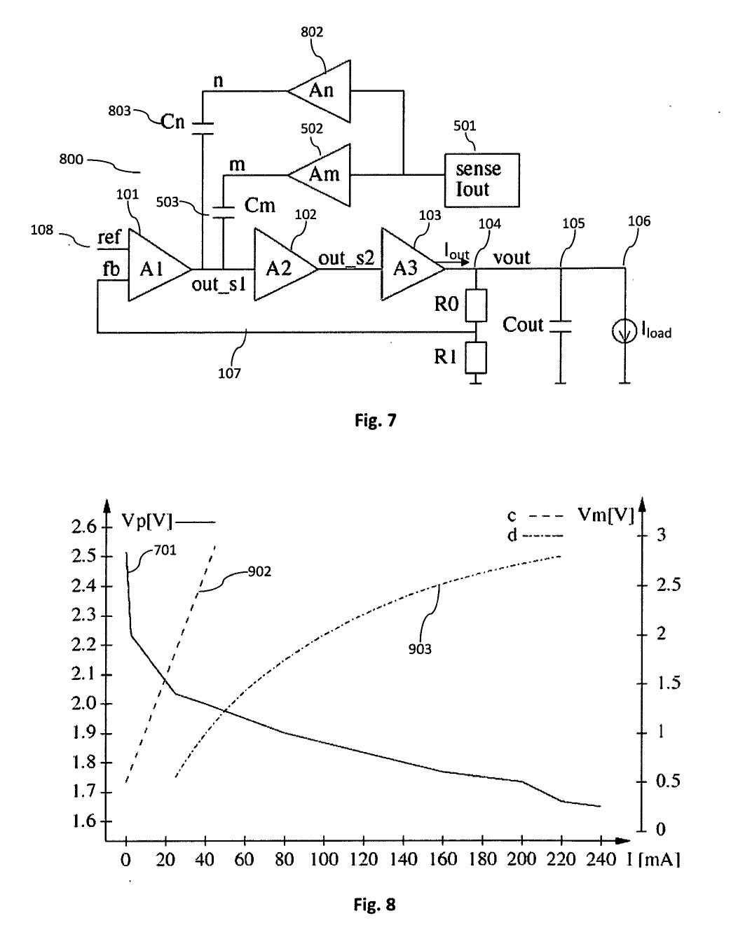

FIG. 7 illustrates an example block diagram of an LDO regulator with multiple load current dependent feedback loops;

FIG. 8 shows example feedback characteristics of an LDO regulator with multiple load current dependent feedback loops;

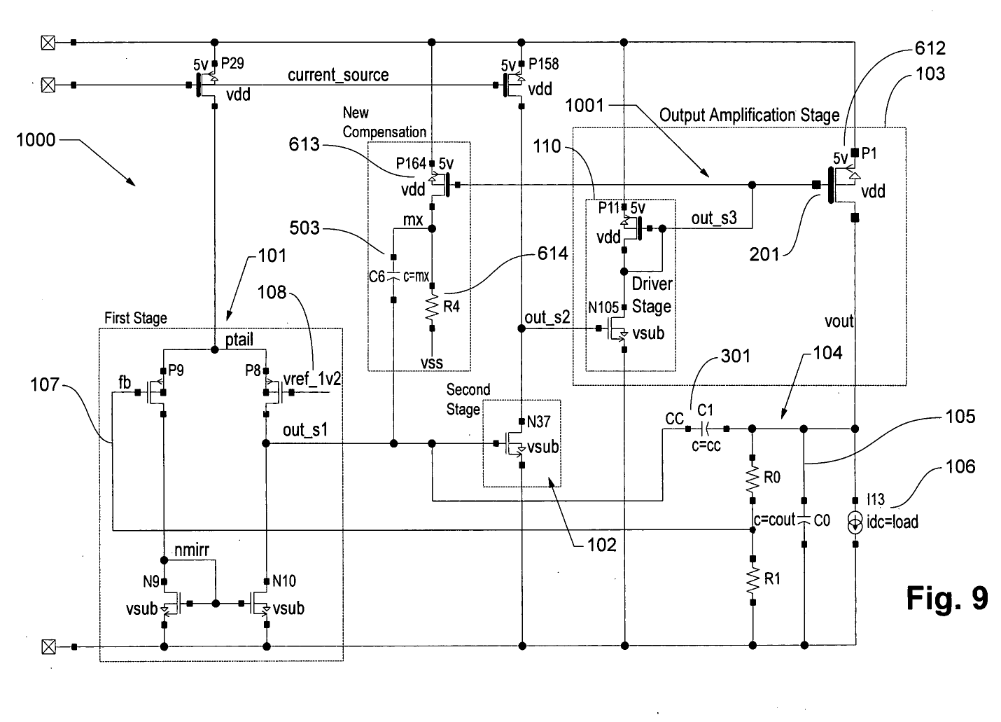

FIG. 9 shows an example circuit arrangement of an LDO regulator with load current dependent feedback;

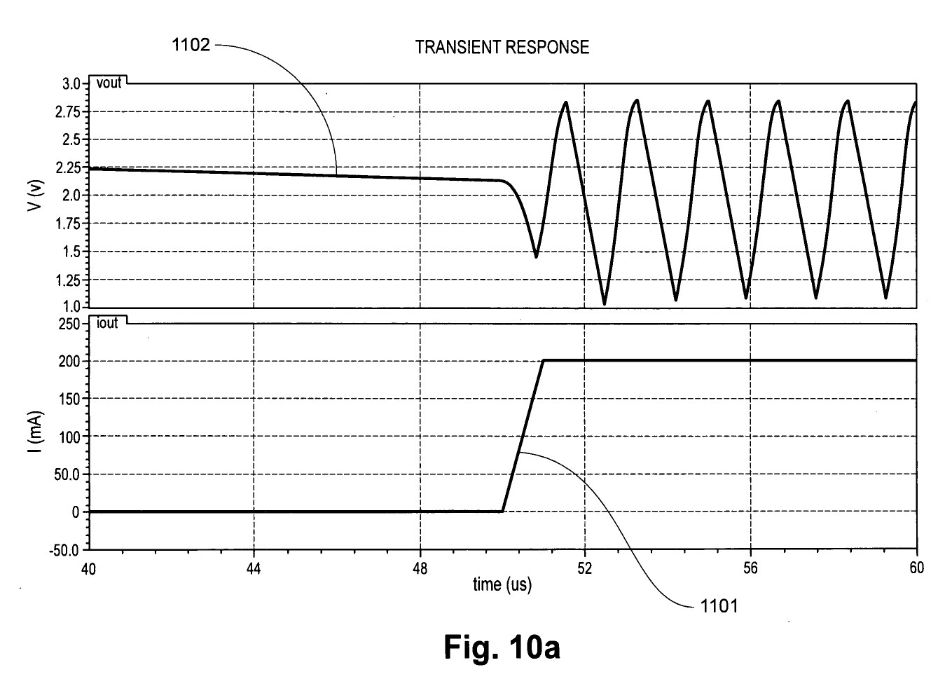

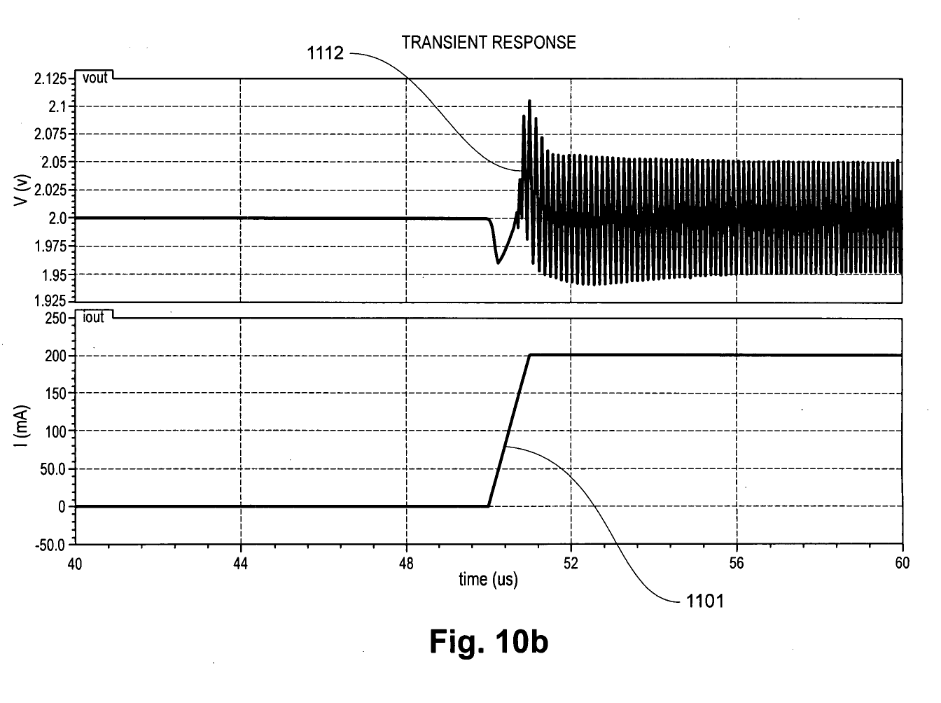

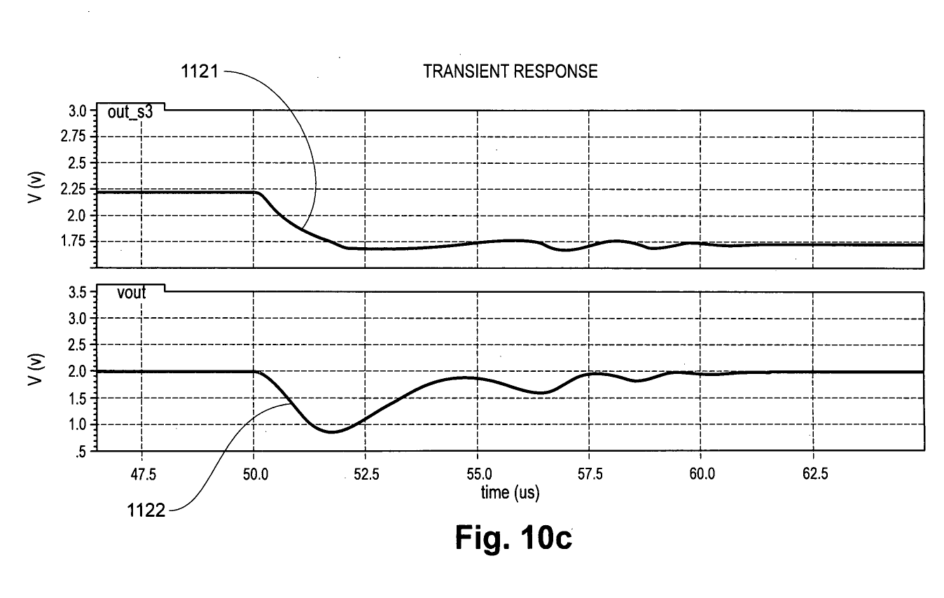

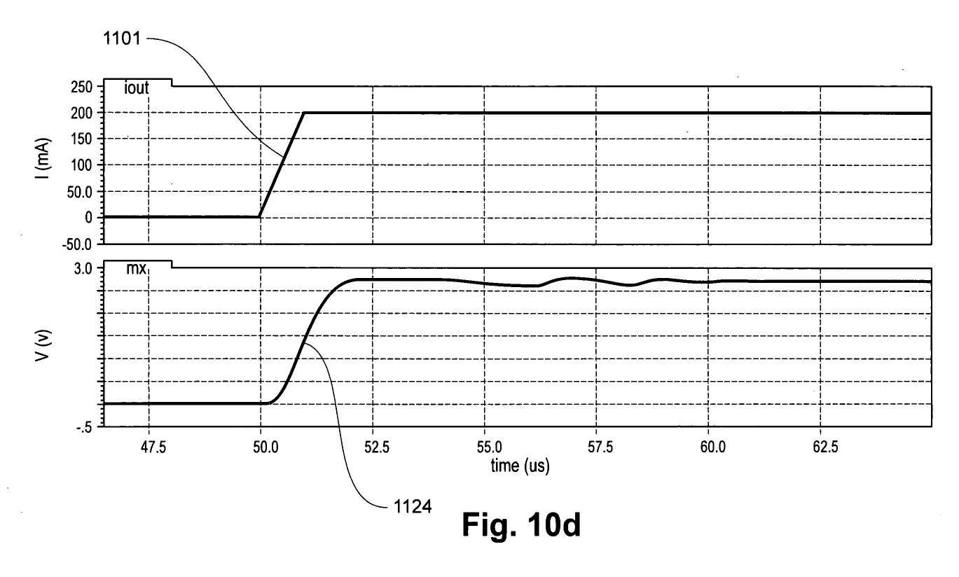

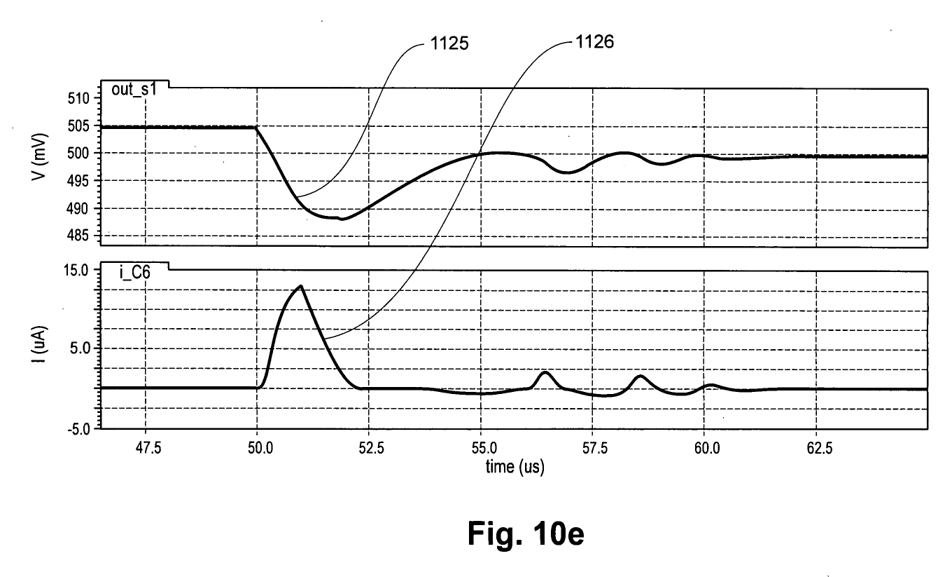

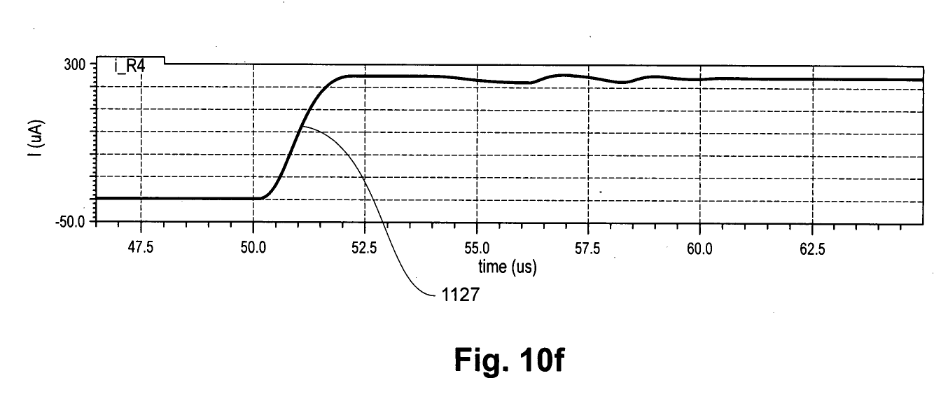

FIG. 10a shows an example transient response of an LDO regulator without any compensation;

FIG. 10b shows an example transient response of an LDO regulator with Miller compensation;

FIG. 10c shows an example transient response of an LDO regulator with load current dependent feedback, i.e. how the compensation current Iₘ of FIG. 10 e influences the output voltage of the differential amplification stage, the potential at the gate of the pass device of the output amplification stage, and ultimately the output voltage of the LDO regulator;

FIG. 10d shows the transient behavior of the LDO regulator during a current load step causing a rising potential Vₘ at node m (labeled mx in FIG. 10d);

FIG. 10e shows how the compensation current Iₘ 1126 influences the output voltage 1125 of the differential amplification stage (labeled out_s1); and

FIG. 10f shows a linear relationship between the scaled output current 1127 (labeled i^{—}R4) at the output of a current mirror and a coupling voltage Vₘ.

As already outlined above, FIG. 1a shows an example block diagram for an LDO regulator 100 with its three amplification stages A1, A2, A3 (reference numerals 101, 102, 103, respectively). FIG. 1b illustrates the block diagram of a LDO regulator 120, wherein the output amplification stage A3 (reference numeral 103) is depicted in more detail. In particular, the pass transistor 201 and the driver stage 110 of the output amplification stage 103 are shown. Typical parameters of an LDO regulator are a supply voltage of 3V, an output voltage of 2V, and an output current or load current ranging from 1 mA to 100 or 200 mA. Other configurations are possible. However, as can be seen in FIG. 10a, the output voltage 1102 cannot be regulated to a fixed value and starts oscillating, subject to a transient load current 1101 (and a corresponding transient output current) increasing sharply from 1 mA to 201 mA.

A possible approach to overcome this instability is to introduce a main compensation or Miller compensation as shown in FIG. 2. FIG. 2 illustrates an example block diagram of a LDO regulator 300 with Miller compensation using an output voltage feedback loop 301 comprising a compensation capacitance C_{V}. The use of Miller compensation may lead to a more stable LDO regulator 300, even with reduced output capacitance Cₒᵤₜ and subject to a transient load current. However, as can be seen in FIG. 10b, when further reducing the output capacitance Cₒᵤₜ, the output voltage 1112 cannot be regulated to a fixed value subject to a transient load current 1101 going from 1 mA to 201 mA. As can be seen in FIG. 10b, the output voltage 1112 oscillates around the target value of 2V.

A possible approach to stabilizing the LDO regulator 300 at reduced output capacitance Cₒᵤₜ could be to increase the capacitance of the Miller compensation C_{V}. However, the use of an increased capacitance C_{V} or the use of multiple Miller compensation loops impacts (i.e. reduces) the regulation speed of the LDO regulator 300, i.e. the time required to reach a stable output voltage subject to a transient load current.

In order to overcome the above mentioned shortcomings, a load current or output current dependent feedback loop is proposed. An example block diagram of a LDO regulator 500 comprising such a load current dependent feedback loop is shown in FIG. 3. The load current dependent feedback loop comprises a load current sensing unit 501 (also referred to as output current sensing unit) which is configured to sense the load current, i.e. the current through the load 106 (i.e. the load current I_{load}) and/or the current at the output of the output amplification stage 103 (i.e. the output current Iₒᵤₜ). The sensed load current (or the sensed output current) may be amplified or attenuated by a load current amplification means 502. The amplified (or attenuated) load current may then be fed back into the amplification path of the LDO regulator 500. This feedback may be coupled into the amplification path using a compensation capacitance Cₘ 503.

In other words, FIG. 3 shows an LDO regulator 500 comprising three amplification stages 101, 102, 103 with an output capacitance Cₒᵤₜ 105 and a load current Iₒᵤₜ at the load 106 and/or at the output of the output amplification stage 103. The load current dependent feedback loop comprises the output current sensing block 501, the gain stage Aₘ 502 and the compensation capacitance Cₘ 503. Output amplification stage 103 may be implemented as shown in FIG. 1b.

Possible implementations of the load current dependent feedback loop are shown in FIG. 4. FIG. 4a shows a schematic illustration of the load current dependent feedback loop 600 including the load current sensing unit 501, the current amplification means 502 and the compensation capacitance Cₘ 503 to couple the feedback signal back into the main amplification path, e.g. at node out_s1 as shown in FIG. 3.

FIG. 4b shows a possible implementation of the load current dependent feedback loop. The load current sensing unit 501 and the current amplification means 502 may be implemented via a current mirror 611 with the ratio 1:M, i.e. with an amplification ratio of 1/M (<1). The current mirror 611 comprises a first transistor 612 and a second transistor 613. The current at the first transistor 612 corresponds to the output current Iₒᵤₜ, wherein the current at the second transistor 613 corresponds to the output current Iₒᵤₜ reduced by the factor M. The gain (or attenuation) value or factor M typically depends on the dimensions of the first and/or second transistor. If the first transistor 612 is N1 and the second transistor 613 is N2, the gain factor

$$M = \frac{{W}_{N 1}}{{L}_{N 1}} \frac{{L}_{N 2}}{{W}_{N 2}} ,$$

wherein

$$\frac{{W}_{N 1}}{{L}_{N 1}}$$

is a width to length ratio of the first transistor N1 and

$$\frac{{W}_{N 2}}{{L}_{N 2}}$$

is a width to length ratio or the second transistor N2.

The load current dependent feedback loop may further comprise a characteristic network or compensation characteristics circuit Z 614. The compensation characteristics circuit Z 614 may be used to tune or set the relationship between the load current I_{load} or output current Iₒᵤₜ and the current which is fed back into the amplification path of the LDO regulator 500. By way of example, the network Z 614 may be a resistor. Other implementations of the network Z 614 are possible and some examples are shown in FIG. 5. As shown in FIG. 4b, the output current of the current mirror 611 is fed to compensation characteristics circuit Z 614 and the compensation capacitance C_{V} 503. The compensation capacitance C_{V} 503 is also connected to the output of the differential amplification stage 101 of the LDO regulator (at node out_s1), thereby providing a load current dependent feedback into the amplification path of the LDO regulator 500.

The load current or output current Iₒᵤₜ is a function of the gate potential of the pass device 201 of the output amplification stage 103. Through the use of the current mirror 611, a scaled current (ratio 1:M) is generated which flows through the characteristics network Z 614. As a result of the scaled current flowing through the network Z 614, a voltage Vₘ is created at the compensation or coupling capacitance Cₘ 503. The compensation or coupling voltage Vₘ is thus dependent on the output current Iₒᵤₜ and on the network Z 614. Thus, the characteristic of the potential Vₘ at the node m, i.e. the voltage Vₘ at one end of the compensation capacitance Cₘ 503, is a function of the output current Iₒᵤₜ or load current I_{load}. This functional relationship between output current Iₒᵤₜ and voltage Vₘ determines the compensation scheme. In particular, the compensation capacitance Cₘ 503 converts a change of the potential Vₘ at the node m at the output of the current amplification means 502 into a compensation or coupling current Iₘ using the relation

$${I}_{m} = {C}_{m} \frac{d {V}_{m}}{d t} ,$$

i.e. the change over time of the compensation voltage Vₘ at node m is proportional to the current through the compensation capacitance Cₘ 503, wherein the proportionality factor is given by the value of the capacitance Cₘ. By feeding the compensation current Iₘ back to the amplification path of the regulator 500, the potential “out_s1” at the input of the intermediate amplification stage 102 and ultimately the gate potential “out_s2” of the pass device 201 of the output amplification stage 103 can be regulated (in addition to the regulation from the regulator output via the main regulation loop). This leads to a stable regulation of the output voltage Vₒᵤₜ.

As such, the load current dependent feedback loop may be implemented using any network Z 614 which converts the (amplified or attenuated) output current Iₒᵤₜ into a potential or voltage Vₘ, thereby allowing for a design or tuning of the desired compensation characteristics. The tuned compensation voltage Vₘ is then converted into a compensation current Iₘ using the compensation capacitance Cₘ. In an embodiment, a current ratio of M=600 of the current mirror 611, a resistor with R=10 kΩ of the network Z 614, and a capacitance with Cₘ=5 pF has been chosen, in order to achieve a linear feedback relationship.

FIG. 5 illustrates example configurations of the compensation characteristics circuit Z 614. As can be seen, the compensation characteristics circuit 614 may comprise a combination of electronic components such as resistors and transistors. Furthermore, the compensation characteristics circuit 614 may comprise switching components such as a bipolar transistor or a NMOS/PMOS transistor. These components may be used to define a function between the sensed load or output current and the coupling or compensation voltage Vₘ.

The overall operation of the load current dependent feedback loop may be described as follows: In case the load current I_{load} or output current Iₒᵤₜ is increasing, the output voltage Vₒᵤₜ of the LDO regulator 500 will typically drop. The main regulation loop 107 of the LDO regulator 500 will consequently regulate the gate potential at the pass device 201 of the output amplification stage 103 to a lower value, in order to allow more current through the pass device 201 and in order to bring the output voltage Vₒᵤₜ back to the desired value (e.g. 2V) as it was before the load current increase. The goal of the compensation is to act partly against the intrinsic regulation of the LDO regulator 500 in a controlled way, and to thereby increase the stability of the LDO regulator 500. When using a load current dependent compensation as shown in FIG. 3, a current flow Iₘ through the capacitance Cₘ 503 will influence the potential “out_s1” at the output of the differential amplification stage 101 of the LDO regulator 500. This current flow Iₘ is a function of the capacitance value Cₘ and the voltage drop dVₘ across the capacitance Cₘ 503 per time interval dt, and is given by the relationship

$${I}_{m} = {C}_{m} \frac{d {V}_{m}}{d t} .$$

The potential “out_s1” at the output of the differential amplification stage 101 of the LDO regulator 500 will be amplified using the intermediate amplification stage 102, thereby yielding the potential “out_s2” which controls (possibly via the driver 110; see FIG. 1b) the pass transistor 201 of the output amplification stage 103, and thereby regulates the output voltage Vₒᵤₜ.

FIG. 9 illustrates an example circuit arrangement of an LDO regulator 1000 comprising a Miller compensation using a capacitance C_{V} 301 and a load current dependent compensation comprising a current mirror 611 with transistors 612 (corresponding to the pass transistor 201) and 613, a compensation characteristics unit 614 and a compensation capacitance Cₘ 503. In the illustrated case, the compensation characteristics unit 614 is implemented by a resistor R=R4.

The circuit implementation of FIG. 9 can be mapped to the block diagrams in FIGS. 1, 2 and 3, as similar components have received the same reference numerals. In the circuit arrangement 1000, the differential amplification stage 101, the intermediate amplification stage 102 and the output amplification stage 103 are implemented using field effect transistors (FET).

The differential amplification stage 101 comprises the differential input pair of transistors P9 and P8, and the current mirror N9 and N10. The input of the differential pair is e.g. a 1.2V reference voltage 108 at P8 and the feedback 107 at P9 which is derived from the resistive divider 104 (with e.g. R0=0.8MΩ and R1=1.2MΩ).

The intermediate amplification stage 102 comprises a transistor N37, wherein the gate of transistor N37 is coupled to the output node of the differential stage 101. The transistor P158 acts as a current source for the intermediate amplification stage 102, similar to transistor P29 which acts as a current source for the differential amplification stage 101.

The output amplification stage 103 comprises a pass device or pass transistor 201 and a gate driver stage 110 for the pass device 201, wherein the gate driver stage comprises a transistor N105 and a transistor P11 connected as diode. This gate driver stage has essentially no gain since it is low-ohmic through the diode connected P11 which yields a resistance of 1/gₘ (output resistance of the driver stage 110 of the output amplification stage 103) to small signal ground. Furthermore, the gate of the pass transistor 201 is identified in FIG. 9 with reference numeral 1001.

The transient behavior of the LDO regulator 500, 1000 during a current load step 1101 is shown in FIG. 10c-10f. One can clearly see that a rising potential Vₘ 1124 at node m (labeled mx in FIG. 10d) causes a current flow Iₘ 1126 (labeled i_C6 in FIG. 10e) through the compensation capacitance Cₘ. In the illustrated case, a resistor R4 was used as a compensation characteristics unit 614, thereby implementing a linear relationship between the scaled output current 1127 (labeled i_R4 in FIG. 10f) at the output of the current mirror 611 and the coupling voltage Vₘ 1124 shown in FIG. 10d. FIGS. 10c-10f also show how the compensation current Iₘ 1126 shown in FIG. 10e influences the output voltage 1125 of the differential amplification stage (labeled out_s1 in FIG. 10e), the potential 1121 (labeled out_s3 in FIG. 10c) at the gate 1001 of the pass device 201 of the output amplification stage 103, and ultimately the output voltage Vₒᵤₜ 1122, shown in FIG. 10c of the LDO regulator 500, 1000. It can be seen that subject to the transient load current 1101, the output voltage Vₒᵤₜ 1122 converges in short time to a stable target voltage value of 2V. This means that a stable voltage regulation can be achieved, even when using a low output capacitance Cₒᵤₜ at 80 nF or lower. It can also be seen that—in contrary to the output voltages Vₒᵤₜ obtained without load current dependent feedback—the output voltage Vₒᵤₜ 1122 of FIG. 10c does not exceed the target voltage value of 2V, even during the convergence phase after the transient load current 1101 of FIG. 10d.

As indicated above, the network Z 614 may be used to define the desired compensation characteristics. In order to provide a linear characteristic, a resistor R4 may be used as illustrated e.g. in FIG. 9. However, one can also design non-linear characteristics in order to improve the compensation mechanism. FIG. 6 shows the potential 701 at the gate 1001 of the pass transistor 201 as a function of the output current Iₒᵤₜ (solid line). Two examples are shown how the load current dependent compensation could be implemented. One type of compensation has a linear characteristic 702 and can be implemented using a resistor R4. By selecting the value of the resistor R4, the slop of the compensation voltage Vₘ as a function of the amplified (or attenuated) load current can be modified. Another type of compensation has a non-linear characteristic 703 and can be implemented by a circuit 614 comprising e.g. one or more resistors, one or more capacitances, and/or one or more inductances. The effectiveness of the current load dependent compensation may be a function of the slope of the potential Vₘ at node m (i.e. a function of the network 614), the size of the capacitance Cₘ 503 and/or the amplification ratio 1:M of the load current amplification means 502.

It should be noted that the load current dependent feedback may be fed back to various points on the amplification path between the output of the differential amplification stage 101 and the input to the output amplification stage 103 (or the gate 1001 of the pass device 201). In particular, the load current dependent feedback may be fed back (alternatively or in addition) to the output of an intermediate amplification stage 102.

As such, the load current dependent compensation scheme may comprise a plurality of compensation paths which may be fed back to the same or to different points on the amplification path of the LDO regulator between the output of the differential amplification stage 101 and the input of the output amplification stage 101 (or the gate 1001 of the pass device 201). An example block diagram of an LDO regulator 800 using two load current dependent compensation paths m and n is shown in FIG. 7. It should be noted that the scheme is not limited to two paths and could be enhanced to a multi-path compensation scheme comprising a plurality of compensation paths. The LDO regulator 800 comprises a load current sensing unit 501 which may be implemented as the first transistor 612 of one or more current mirrors 611. In particular, the load current sensing unit 501 may correspond to the pass transistor 201 being the first transistor 612 of a current mirror 611. Furthermore, the LDO regulator 800 comprises two load current amplification units 502 and 802 which apply two different current amplification or attenuation ratios (1:M and 1:N, respectively). The load current amplification means may be implemented as two respective second transistors 613 of two current mirrors 611. At the output of the amplification means 502, 802, the load current dependent feedback loops may provide compensation voltages Vₘ and Vₙ, respectively. These voltages (or the change of these voltages as a function of a change of the load current Iₒᵤₜ) may be fed back to the amplification path of the LDO regulator 800 as compensation currents Iₘ and Iₙ, respectively, through the use of compensation capacitances Cₘ and Cₙ, respectively. The feedback of the compensation currents Iₘ and Iₙ to the amplification path may be performed at the same or at different points between the output of the differential amplification stage 101 and the input of the output amplification stage 103. Furthermore, the compensation currents Iₘ and Iₙ may be generated using separate and possibly different networks Zₙ and Zₘ.

FIG. 8 shows how a current load dependent compensation scheme comprising multiple compensation paths may be used to implement an efficient compensation for various load current values. A first feedback path (e.g. feedback path n in FIG. 7) may be configured to provide an efficient compensation 902 for low load currents Iₒᵤₜ. On the other hand, a second feedback path (e.g. feedback path m in FIG. 7) may provide an efficient compensation 903 for higher load currents Iₒᵤₜ. The parameters of the feedback paths (i.e. the amplification ratio 1:M or 1:N, the networks Zₙ and Zₘ 614 and the capacitances Cₘ, Cₙ) may be designed such that the load current ranges are complementary or overlap for an efficient compensation. Alternatively or in addition, the feedback paths can be implemented in various ways using linear or non-linear characteristics.

In the present document, compensation schemes for LDO regulators have been described which allow for a stable regulation of the output voltage, subject to transient load currents. This stable regulation is achieved even when using low values for the output capacitance Cₒᵤₜ, thereby enabling a simplified manufacturing of the LDO regulator circuit and a reduced footprint. In particular, the use of low or ultra low values for the output capacitance Cₒᵤₜ enables the integration of the LDO regulator circuit and the output capacitance Cₒᵤₜ within a package. Furthermore, it becomes possible to monolithically integrate the output capacitance Cₒᵤₜ on the silicon chip itself.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiment outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. A linear regulator configured to regulate an output voltage subject to a reference voltage, the regulator comprising
a differential amplification stage configured to amplify a difference, at an input of the differential amplification stage, between the reference voltage and a measure of the output voltage, thereby yielding an output current at an output of the differential amplification stage;
a subsequent output amplification stage configured to provide the regulated output voltage and an output current at an output of the output amplification stage, based on a drive voltage at an input of the output amplification stage; and
a first output current feedback loop configured to
sense the output current; and
feed back a first coupling current derived from the sensed output current to a first intermediate point between the output of the differential amplification stage and the input of the output amplification stage;
wherein the drive voltage is dependent on the output current of the differential amplification stage and the first coupling current.

2. The regulator of claim 1, wherein the first output current feedback loop comprises
output current sensing means configured to sense the output current at the output of the output amplification stage.

3. The regulator of claim 1, wherein the first output current feedback loop comprises
output current amplification means configured to amplify or attenuate the sensed output current, thereby yielding a scaled output current.

4. The regulator of claim 1, wherein
the output amplification stage comprises a pass transistor having a gate, a source and a drain;
the output voltage is the voltage at the drain of the pass transistor;
the output current is the source to drain current of the pass transistor; and
the first output current feedback loop comprises a feedback transistor.

5. The regulator of claim 3, wherein the first output current feedback loop comprises
a current coupling unit configured to provide the first coupling current from the scaled output current.

6. The regulator of claim 5, wherein the current coupling unit comprises
a coupling characteristics circuit configured to convert the scaled output current into a coupling voltage; and
a coupling capacitance, configured to convert a change of the coupling voltage into the first coupling current.

7. The regulator of claim 6, wherein the coupling characteristics circuit comprises any combination of:
one or more resistors;
one or more transistors;
one or more diodes;
one or more capacitances; and
one or more inductances.

8. The regulator of claim 1, wherein
an output of the first output current feedback loop is coupled with the output of the differential amplification stage at the first intermediate point.

9. The regulator of claim 1, further comprising one or more intermediate amplification stages coupled between the output of the differential amplification stage and the input of the output amplification stage.

10. The regulator of claim 9, wherein the first intermediate point is positioned between:
the output of the differential amplification stage and an input of the one or more intermediate amplification stages;
an output of the one or more intermediate amplification stages and the input of the output amplification stage; or
an output of a first intermediate amplification stage and an input of a second intermediate amplification stage, if the regulator comprises more than one intermediate amplification stage.

11. The regulator claim 1, further comprising
a second output current feedback loop configured to feed back a second coupling current derived from the sensed output current to the first intermediate point, or a different second intermediate point between the output of the differential amplification stage and the input of the output amplification stage, wherein the drive voltage is further dependent on the second coupling current.

12. The regulator of claim 11, wherein the first and second output current feedback loops are configured such that the first and second coupling currents exceed a threshold current for different ranges of the sensed output current.

13. The regulator claim 1, wherein
the output voltage is in the range of 1V to 5.5V;
the output current is in the range of 1 mA to 400 mA; and
an output capacitance parallel to a load of the regulator is smaller or equal to 200 nF.

14. The regulator claim 1, further comprising a Miller compensation loop configured to feed back the output voltage to a third intermediate point between the output of the differential amplification stage and the input of the output amplification stage, wherein the Miller compensation loop comprises a Miller capacitance.

15. A method for regulating an output voltage subject to a reference voltage, the method comprising
amplifying a difference between the reference voltage and a measure of the output voltage, thereby yielding an output current at an output of a differential amplification stage;
providing the regulated output voltage and an output current at an output of an output amplification stage, based on a drive voltage at an input of the output amplification stage;
sensing the output current; and
feeding back a first coupling current derived from the sensed output current to a first intermediate point between the output of the differential amplification stage and the input of the output amplification stage;
wherein the drive voltage is dependent on the output current of the differential amplification stage and the first coupling current.

16. The method of claim 15, further comprising sensing the output current at the output of the first output amplification stage by an output current sensing means.

17. The method of claim 15, further comprising amplifying or attenuating the sensed output current by an output current amplification means, thereby yielding a scaled output current.

18. The method of claim 15, further comprising providing the first coupling current from a scaled output current.

19. The method of claim 18, further comprising converting the scaled output current into a coupling voltage and converting a change of the coupling voltage into the first coupling current.

20. The method of claim 15, further comprising configuring a second output current feedback loop to feed back a second coupling current derived from the sensed output current to the first intermediate point, or a different second intermediate point between the output of the differential amplification stage and the input of the output amplification stage.

21. The method of claim 20, further comprising configuring the first and second output current feedback loops such that the first and second coupling currents exceed a threshold current for different ranges of the sensed output current.

22. The method of claim 15, further comprising configuring a Miller compensation loop to feed back the output voltage to a third intermediate point between the output of the differential amplification stage and the input of the output amplification stage, wherein the Miller compensation loop comprises a Miller capacitance.
